(19) United States
(12) Patent Application Publication
(10) Pub. No.: US 2012/0294445 A1
(43) Pub. Date: Nov. 22, 2012

(54) CREDENTIAL STORAGE STRUCTURE WITH ENCRYPTED PASSWORD

(75) Inventors: Aleksandr Radutskiy, Redmond, WA (US); Andrew R. Bernat, Bellevue, WA (US); Magnus Bo Gustaf Nyström, Sammamish, WA (US); Denis Issoupov, Bellevue, WA (US)

(73) Assignee: MICROSOFT CORPORATION, Redmond, WA (US)

(21) Appl. No.: 13/108,883

(22) Filed: May 16, 2011

(51) Int. Cl. H04L 9/06; H04L 9/08

(52) U.S. Cl. 380/278; 380/277

(57) ABSTRACT

In accordance with one or more aspects, a storage structure including both an encrypted credential and an encrypted password is obtained. A key can be obtained from a key distribution service and the encrypted password decrypted, based on the key, to obtain a password. The encrypted credential is decrypted, based on the password to obtain the credential. Both devices able to obtain the key from the key distribution service, and devices otherwise able to obtain the password, are able to obtain the credential by decrypting the encrypted credential.

### BACKGROUND

A variety of different data is available to computers today, and oftentimes the user of the computer desires to protect the data from being accessed by unauthorized users. One way in which such protection can be implemented is password-based protection, where data is encrypted using a key that is derived from a password that only users that are allowed to access the data know. While such protection is useful, it is not without its problems. One such problem is that passwords may be handwritten by users on paper notes or stored in other files on the computer that are not protected. This results in some of the protection of the data being lost because unauthorized users can obtain the password from the handwritten note or other unprotected files, and use the password to access the protected data.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a storage structure including an encrypted credential is obtained. This encrypted credential is a credential encrypted based on a password. A key is obtained (e.g., from a key distribution service), and an encrypted password is generated by encrypting the password based on the obtained key. The encrypted password is also included as part of the storage structure.

In accordance with one or more aspects, a storage structure including both an encrypted credential and an encrypted password is obtained. A password is obtained by decrypting the encrypted password based on a key (e.g., a key obtained from a key distribution service). The encrypted credential is decrypted based on the password to obtain the credential.

### BRIEF DESCRIPTION OF THE DRAWINGS

The same numbers are used throughout the drawings to reference like features.

FIG. 1 illustrates an example system implementing the credential storage structure with encrypted password in accordance with one or more embodiments.

FIG. 2 illustrates an example credential storage structure in accordance with one or more embodiments.

FIG. 3 is a flowchart illustrating an example process for generating a storage structure in accordance with one or more embodiments.

FIG. 4 is a flowchart illustrating an example process for retrieving a credential from a storage structure in accordance with one or more embodiments.

FIG. 5 illustrates an example computing device that can be configured to implement various techniques involving the credential storage structure with encrypted password in accordance with one or more embodiments.

### DETAILED DESCRIPTION

A credential storage structure with encrypted password is discussed herein. A storage structure stores a credential (such as a private key of a public/private key pair) encrypted based on a password. The storage structure also stores the password encrypted based on a key. The credential can be obtained from the storage structure in multiple different ways. If the password is known, then the credential can be obtained from the storage structure by decrypting the credential based on the password. If the key is already known, then the password can be obtained from the storage structure by decrypting the password based on the key, and then the credential can be obtained from the storage structure by decrypting the credential based on the password. If the key can be obtained (e.g., from a key distribution service), then the password can be obtained from the storage structure by decrypting the password based on the key, and then the credential can be obtained from the storage structure by decrypting the credential based on the password.

References are made herein to cryptography, which can include symmetric key cryptography, public key cryptography and public/private key pairs. Although such key cryptography is well-known to those skilled in the art, a brief overview of such cryptography is included here to assist the reader. In public key cryptography, an entity (such as a user, hardware or software component, a device, a domain, and so forth) has a key (a public key and/or a private key). The public key of a public/private key pair can be made publicly available, but the private key is kept a secret. Without the private key it is computationally very difficult to decrypt data that is encrypted using the public key. Using some public key cryptography algorithms, data can be encrypted by any entity with the public key and only decrypted by an entity with the corresponding private key. Additionally, using some public key cryptography algorithms, a digital signature for data can be generated by using the data and the private key. Without the private key it is computationally very difficult to create a signature that can be verified using the public key. Any entity with the public key can use the public key to verify the digital signature by executing a suitable digital signature verification algorithm on the public key, the signature, and the data that was signed.

In symmetric key cryptography, on the other hand, a shared key (also referred to as a symmetric key) is known by and kept secret by the two entities. Any entity having the shared key is typically able to decrypt data encrypted with that shared key. Without the shared key it is computationally very difficult to decrypt data that is encrypted with the shared key. So, if two entities both know the shared key, each can encrypt data that can be decrypted by the other, but other entities cannot decrypt the data if the other entities do not know the shared key. Similarly, an entity with a shared key can encrypt data that can be decrypted by that same entity, but other entities cannot decrypt the data if the other entities do not know the shared key. Additionally, authentication codes or message authentication codes can be generated based on symmetric key cryptography, such as using a keyed-hash message authentication code mechanism. Any entity with the shared key can generate and verify the authentication code or message authentication code. For example, a trusted third party can generate a symmetric key based on an identity of a particular entity, and then can both generate and verify the authentication codes or message authentication codes for that particular entity (e.g., by encrypting or decrypting the data using the symmetric key).

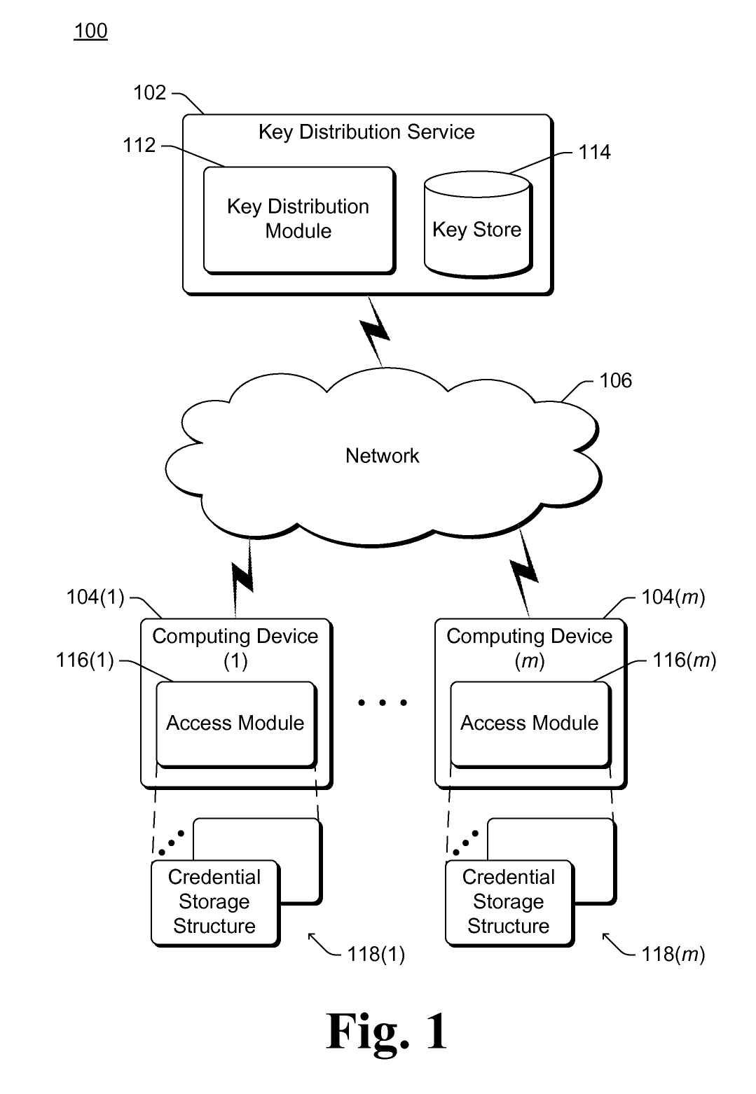

FIG. 1 illustrates an example system 100 implementing the credential storage structure with encrypted password in accordance with one or more embodiments. System 100 includes a key distribution service 102 and one or more (m) computing devices 104 that can communicate with one another via a network 106. Network 106 can be a variety of different networks, including the Internet, a local area network (LAN), a wide area network (WAN), a personal area network (PAN), a public telephone network, an intranet, other public and/or proprietary networks, combinations thereof, and so forth.

Each computing device 104 can be a variety of different types of devices, such as a physical device or a virtual device. For example, a computing device 104 can be a desktop computer, a server computer, a laptop or netbook computer, a tablet or notepad computer, a mobile station, an entertainment appliance, a set-top box communicatively coupled to a display device, a television or other display device, a cellular or other wireless phone, a game console, an automotive computer, and so forth. A computing device 104 can also be a virtual device, such as a virtual machine running on a physical device. A virtual machine can be run on any of a variety of different types of physical devices (e.g., any of the various types listed above). Thus, computing devices 104 may range from full resource devices with substantial memory and processor resources (e.g., personal computers, game consoles) to low-resource devices with limited memory and/or processing resources (e.g., traditional set-top boxes, hand-held game consoles). Additionally, different ones of computing devices 104 can be different types of devices.

Key distribution service 102 provides various key management functionality, including key storage and distribution, to computing devices 104. Key distribution service 102 can be implemented by one computing device or multiple computing devices (of the same or different types). Similar to the discussion of computing devices 104, key distribution service 102 can be implemented by a variety of different types of computing devices, ranging from full resource devices with substantial memory and processor resources to low-resource devices with limited memory and/or processing resources.

Key distribution service 102 includes a key distribution module 112 and a key store 114. Key distribution module 112 receives requests for keys from computing devices 104, and returns the requested key to the requesting device 104 if the requesting device 104 is permitted to access the requested key. The key requested by a computing device 104 can be a symmetric key, a public key of a public/private key pair, or a private key of a public/private key pair, and can be used to encrypt and/or decrypt a password as discussed below. The keys are maintained by key distribution service 102 in key store 114. Key store 114 can be implemented using a variety of different storage technologies, such as magnetic disks, optical discs, random access memory (RAM), Flash memory, combinations thereof, and so forth. Various different symmetric key cryptography and/or public key cryptography algorithms can be used to encrypt and/or decrypt credentials and passwords as discussed herein, such as the Advanced Encryption Standard (AES) algorithm, the Diffie-Hellman-Merkle algorithm, and so forth.

Computing devices 104 include access modules 116. Access modules 116 manage access to data using one or more credential storage structures 118. Access modules 116 can allow computing device 104 to access data based on one or more credential storage structures 118, and/or generate one or more credential storage structures 118.

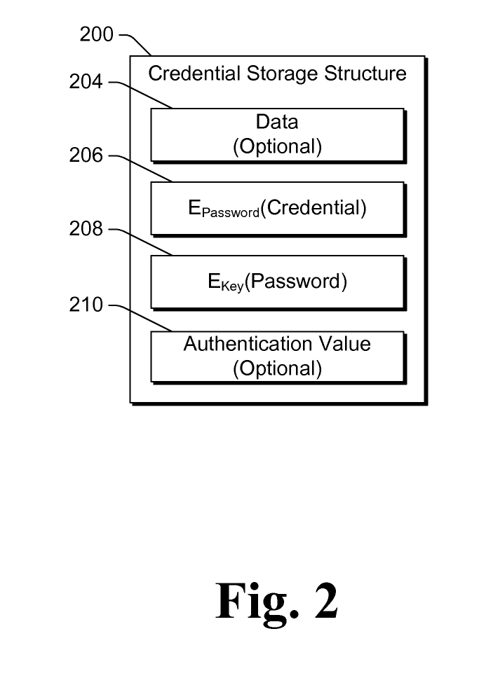

FIG. 2 illustrates an example credential storage structure 200 in accordance with one or more embodiments. Credential storage structure 200 can be a credential storage structure 118 of FIG. 1. Credential storage structure 200 is a data structure that includes an optional data portion 204, an encrypted credential portion 206, an encrypted password portion 208, and an optional authentication value portion 210. Credential storage structure 200 can also be referred to as an enveloped data structure due to credential storage structure 200 including a credential encrypted with a password.

Encrypted credential portion 206 includes a credential encrypted based on a password. The notation “E_{Password}(Credential)” refers to the credential “Credential” encrypted based on the password “Password”. This credential in encrypted credential portion 206 can be used in different manners, such as to access data, access or provide functionality of a system, and so forth, and can take a variety of different forms. For example, the credential can be a private key of a public/private key pair, a symmetric key, a password, and so forth. The credential is encrypted based on a key derived from a password using any of a variety of different well-known (or alternatively proprietary) key derivation and encryption algorithms.

Data portion 204 is optional and need not be included in credential storage structure 200. In situations in which data portion 204 is included in credential storage structure 200, data portion 204 includes data that is associated with credential storage structure 200. Data portion 204 can be associated with the credential encrypted in encrypted credential portion 206, and/or with the data or functionality that the credential encrypted in encrypted credential portion 206 is used to access. Data portion 204 can include, for example, a digital certificate associated with the credential encrypted in encrypted credential portion 206 (e.g., in situations in which the credential contains a private key of a public/private key pair), a digital certificate revocation list, and so forth. Data portion 204 is also optionally encrypted, analogous to encryption of the credential in encrypted credential portion 206.

Encrypted password portion 208 includes a password encrypted based on a key. The notation “E_{Key}(Password)” refers to the password “Password” encrypted based on the key “Key”. This password in encrypted password portion 208 is the password used to decrypt encrypted credential portion 206 in order to obtain the credential (which is the same password as is used to generate encrypted credential portion 206). The password is encrypted based on a key using any of a variety of different well-known (or alternatively proprietary) encryption algorithms, including symmetric key cryptography algorithms (in which case the key is a symmetric key) and/or public key cryptography algorithms (in which case the key is a public key of a public/private key pair). The encryption algorithm uses a key to encrypt the credential, such as by using the key as a key for the encryption algorithm, deriving from the key another value to use as a key for the encryption algorithm, and so forth.

Authentication value portion 210 is optional and need not be included in credential storage structure 200. In situations in which authentication value portion 210 is included in credential storage structure 200, authentication value portion 210 includes an authentication value generated based on one or more of data portion 204, encrypted credential portion 206, and encrypted password portion 208. The authentication value in portion 210 can be generated using a variety of different well-known (or alternatively proprietary) authentication algorithms that generate, based on an input, a value that allows a determination to be made as to whether the input has been changed. The authentication algorithm used to generate the authentication value in portion 210 can be based on a message authentication code (MAC) or hash-based message authentication code (HMAC), although other authentication algorithms can alternatively be used. For example, the authentication algorithm used can be DES3-CBC-MAC (Triple Data Encryption Standard Cipher Block Chaining Message Authentication Code), HMAC with SHA-1 (Secure Hash Algorithm 1), and so forth. Such a MAC or HMAC can optionally be generated based on the password used to generate encrypted credential portion 206 (e.g., the MAC or HMAC can use a key derived from the password). The authentication algorithm can then subsequently be used with the same inputs and the result compared to the authentication value stored in portion 210. If the newly generated authentication value and the authentication value stored in portion 210 are the same, then the determination can be made that the inputs have not been changed; otherwise, the determination can be made that the inputs have been changed. Various actions can be taken if it is determined that the inputs have been changed, such as credential storage structure 200 (e.g., one or more of data portion 204, encrypted credential portion 206, and encrypted password portion 208) not being used or relied on, a notification being communicated to a system administrator, and so forth.

In one or more embodiments, the input to the authentication algorithm is the data in portion 204, the encrypted credential in portion 206, and the encrypted password in portion 208, resulting in an authentication value that is stored in portion 210. In other embodiments, the input to the authentication algorithm is only one (or two) of the data in portion 204, the encrypted credential in portion 206, and the encrypted password in portion 208. For example, the input to the authentication algorithm can be the encrypted credential in portion 206 and the encrypted password in portion 208, but not the data in portion 204.

Additionally, although credential storage structure 200 is illustrated as including a single portion 204, a single portion 206, a single portion 208, and a single portion 210, alternatively multiple portions 204, 206, 208, and/or 210 can be included in storage structure 200. For example, multiple sets of portions 204, 206, 208, and 210 can be included in storage structure 200 for multiple different credentials. By way of another example, multiple sets of portions 204, 206, and 208 can be included in storage structure 200 for multiple different credentials, and a single authentication value 210 can be included in storage structure 200 (e.g., by using the multiple sets of portions 204, 206, and 208 as inputs to the authentication algorithm to generate authentication value 210).

The encrypted credential in encrypted credential portion 206 can be decrypted by authorized entities and used in a variety of different manners. For example, an access module 116 of FIG. 1 can decrypt the encrypted credential and use the credential to access data stored on a computing device 104 of FIG. 1. By way of another example, an access module 116 can decrypt the encrypted credential and use the credential to establish a secure communication channel (e.g., a secure sockets layer (SSL) or transport layer security (TLS) communication channel) with another computing device 104.

The encrypted credential in encrypted credential portion 206 can be decrypted by an authorized entity (e.g., an authorized access module 116 of FIG. 1), which is an entity that is entitled or permitted to access the credential. Such an entity can be, for example, a computing device 104 and/or access module 116 of FIG. 1. The authorized entity is aware of the password or can obtain the password (e.g., from encrypted password portion 208) and use the password to decrypt the encrypted credential in encrypted credential portion 206. The authorized entity can be aware of or obtain the password in different manners.

In one or more embodiments, an authorized entity is an entity that is authenticated by a key distribution service 102 of FIG. 1. The entity provides various authentication information to key distribution service 102, such as a user or device identifier and password, a group identifier and password, an identifier of the entity and/or a desired key, a certificate or other information proving the identity of the entity, and so forth. Key distribution service 102 can authenticate the received authentication information in various manners, such as by checking the information against a record of authorized entities and their associated authentication information, inputting the authentication information to an algorithm to determine whether the authentication information is from an authorized entity, providing the authentication information to another service that determines whether the authentication information is from an authorized entity, and so forth.

If key distribution service 102 authenticates the authentication information from the entity, verifying that the authentication information indicates that the entity is an authorized entity, then a key from key store 114 is returned to the entity. The particular key from key store 114 that is returned can be identified in different manners, such as being a key associated in key store with the authorized entity, being a key associated in a key store with a group of which the authorized entity has been authenticated as being a part of, being a key requested by the entity, and so forth. The key returned is the key used to decrypt the password in encrypted password portion 208, and can be a symmetric key or a private key of a public/private key pair. The entity (e.g., an access module 116 of FIG. 1) can then use the key to decrypt the password (in encrypted password portion 208), which it can in turn use to decrypt the credential (in encrypted credential portion 206). The access module can use the password to decrypt the credential without revealing the password to the user of the device (e.g., device 104 of FIG. 1) and/or to other modules or components of the device (e.g., device 104 of FIG. 1).

Alternatively, rather than authenticating the received information, key distribution service 102 can protect the key in a manner allowing only authorized entities to obtain the key without significant computational difficulty. For example, key distribution service 102 can encrypt the key with a public key of a public/private key pair associated with the authorized entities. Authorized entities can thus readily decrypt the key using the private key of the public/private key pair, but other entities that do not have the private key cannot decrypt the key without significant computational difficulty.

In one or more other embodiments an authorized entity is an entity that has a key that can be used to decrypt the password in encrypted password portion 208. For example, credential storage structure 200 can be generated by a device that shares a symmetric key with other devices that are authorized entities, and this symmetric key can be used to encrypt the password to generate the encrypted password in encrypted password portion 208. Any device that also has this symmetric key can use the symmetric key to decrypt the password in encrypted password portion 208, and in turn use the password to decrypt the credential in encrypted credential portion 206. By way of another example, credential storage structure 200 can be generated by a device using a public key of a public/private key pair, the authorized entities being aware of the private key of the public/private key pair. The public key can be used to encrypt the password to generate the encrypted password in encrypted password portion 208. Any device that also has the private key can use the private key to decrypt the password in encrypted password portion 208, and in turn use the password to decrypt the credential in encrypted credential portion 206.

Furthermore, an entity that otherwise has access to the password that is used to decrypt the credential in encrypted credential portion 206 is an authorized entity. For example, a user of a computing device 104 of FIG. 1 can be aware of the password and provide the password to access module 116, making access module 116 an authorized entity. The password can be used to decrypt the credential in encrypted credential portion 206 regardless of whether the key to decrypt the password in encrypted password portion 208 is known.

Credential storage structure 200 is generated by a computing device, such as by an access module 116 of a computing device 104 of FIG. 1. In one or more embodiments, the access module authenticates itself to the key distribution service as being an authorized entity, analogous to the discussion above regarding an authorized entity obtaining a key to decrypt the password in encrypted password portion 208. In such embodiments, the access module obtains a symmetric key from the key distribution service, which is the same key as an authorized entity obtains to decrypt the password in encrypted password portion 208. The symmetric key received from the key distribution service is then used to encrypt the password, and the encrypted password is included as part of storage structure 200 (in encrypted password portion 208).

In other embodiments, the access module obtains a public key of a public/private key pair from the key distribution service. The public/private key pair is associated with a particular computing device or a particular group of computing devices, all of which are aware of (or have access to, such as from the key distribution service) the private key of the public/private key pair. The access module need not be part of the particular group and need not authenticate itself to the key distribution service, but can still obtain the public key of the public/private key pair from the key distribution service. The access module can then encrypt the password based on the public key, allowing devices that are part of the particular group to obtain the password by decrypting the encrypted password based on the private key of the public/private key pair.

In other embodiments, the access module can have knowledge of or otherwise obtain the key (symmetric key or public key) to encrypt the password in other manners. For example, the access module can obtain the key to use to encrypt the password from another service, component, or device. By way of another example, the access module can be pre-configured with the key or otherwise have knowledge of the key to use to encrypt the password.

Thus, credential storage structure 200 stores the credential in a protected manner, encrypted based on the password, and various different techniques can be used to obtain the password. For example, at a computing device 104 where a user of the device knows the password, the password can be provided to access module 116 and used to decrypt the credential in encrypted credential portion 206. However, at another computing device 104 where the user of the device does not know the password, the key can be obtained by (or otherwise be known to) access module 116, which can use the key to obtain the password and decrypt the credential in encrypted credential portion 206.

In one or more embodiments, credential storage structure 200 is based on the PKCS #12 standard with the addition of the encrypted password portion 208, although the addition of the encrypted password portion 208 does not prevent the encrypted credential portion from being decrypted by devices based on the password alone (without obtaining the password from encrypted password portion 208). Additional information regarding the PKCS #12 standard can be found in “PKCS 12 v1.0: Personal Information Exchange Syntax” from RSA Laboratories. Thus, devices able to obtain the credential from an encrypted credential of a PKCS #12 file can (assuming the correct password is known) obtain the credential from encrypted credential portion 206 without knowledge of the key or how to obtain the password from encrypted key portion 208.

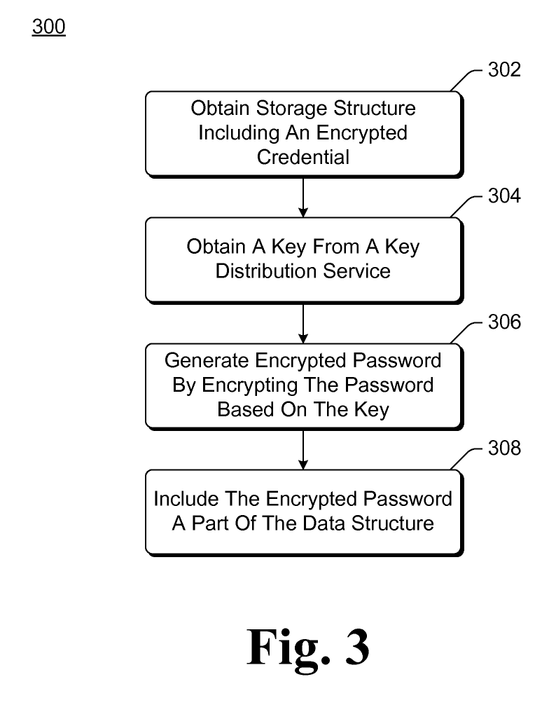

FIG. 3 is a flowchart illustrating an example process 300 for generating a storage structure in accordance with one or more embodiments. Process 300 is carried out by a computing device, such as a computing device 104 of FIG. 1, and can be implemented in software, firmware, hardware, or combinations thereof. Process 300 is shown as a set of acts and is not limited to the order shown for performing the operations of the various acts. Process 300 is an example process for generating a storage structure; additional discussions of generating a storage structure are included herein with reference to different figures.

In process 300, a storage structure including an encrypted credential is obtained (act 302). The encrypted credential is encrypted based on a password, as discussed above. The storage structure can be obtained by being generated by the device implementing process 300, including obtaining the credential from another device or service (or generating the credential), and encrypting the credential based on the password (and optionally generating the password itself). Alternatively, the storage structure can be obtained by the device implementing process 300 from another device or service.

A key is obtained (act 304). The key can be obtained from a key distribution service, or alternatively can be obtained elsewhere or be otherwise known to the device implementing process 300 as discussed above. The key can be a symmetric key, or a public key of a public/private key pair as discussed above.

An encrypted password is generated by encrypting the password based on the obtained key (act 306). The password that is encrypted is the same password as is the basis for encryption of the encrypted credential, as discussed above.

The encrypted password is included as part of the storage structure (act 308). Additional values or data can also be generated or obtained and included in the storage structure, such as data in a data portion and/or an authentication value as discussed above.

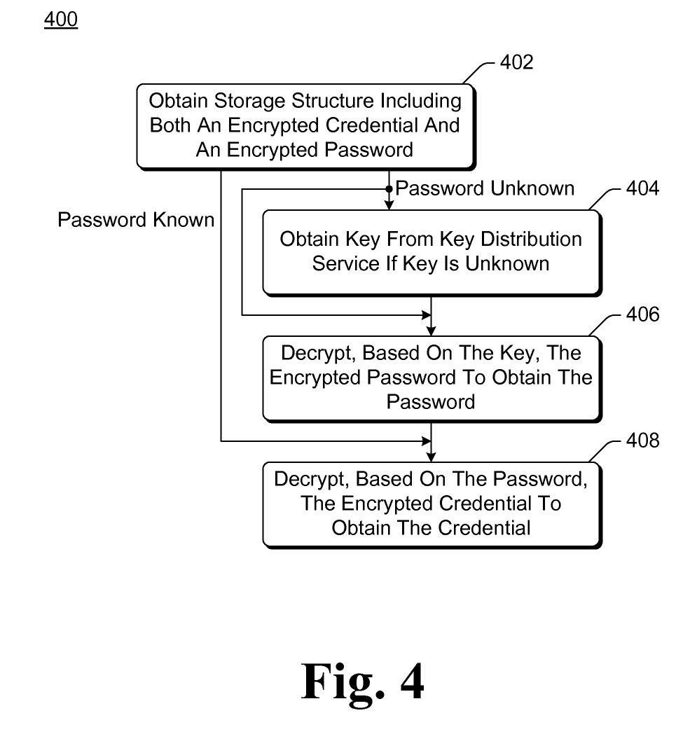

FIG. 4 is a flowchart illustrating an example process 400 for retrieving a credential from a storage structure in accordance with one or more embodiments. Process 400 is carried out by a computing device, such as a computing device 104 of FIG. 1, and can be implemented in software, firmware, hardware, or combinations thereof. Process 400 is shown as a set of acts and is not limited to the order shown for performing the operations of the various acts. Process 400 is an example process for retrieving a credential from a storage structure; additional discussions of retrieving a credential from a storage structure are included herein with reference to different figures.

In process 400, a storage structure including both an encrypted credential and an encrypted password is obtained (act 402). The password is encrypted based on a key, and the credential is encrypted based on the password, as discussed above. The storage structure can be obtained in various different manners from various different devices, such as being sent or otherwise communicated to the device implementing process 400, being retrieved by the device implementing process 400, and so forth.

Process 400 proceeds based on whether the password that was the basis for generating the encrypted credential is known to the device implementing process 400. The password can be known to the device implementing process 400 in different manners, such as being provided by a user of the device, being obtained from a file accessible to the device, and so forth. If the password is not known (is unknown), then the key is obtained from a key distribution service if the key is unknown (act 404). The key in act 404 is the key that is used to decrypt the encrypted password (e.g., a symmetric key or private key of a public/private key pair). If the key used to decrypt the encrypted password is known, then process 400 can proceed from act 402 to act 406 without accessing the key service.

The encrypted password is decrypted, based on the key, to obtain the password (act 406). The key in act 406 is the key that is obtained in act 404 or the key that is otherwise known to the device implementing process 400.

The encrypted credential is decrypted, based on the password, to obtain the credential (act 408). The password in act 408 can be the password obtained in act 406. Alternatively, returning to act 402, if the password is known, then process 400 proceeds from act 402 to act 408, in which the known password is used to obtain the credential by decrypting the encrypted credential.

The techniques involving the credential storage structure with encrypted password discussed herein support various usage scenarios. For example, multiple different devices can operate together to provide a particular service to other computing devices (e.g., email services, social networking services, audio and/or video playback services, etc.). These different devices can use the same public/private key pair, the private key of which is a credential that is encrypted and stored in a credential storage structure. Ones of these different devices that are able to access a key distribution service can readily access the key distribution service to obtain a key to decrypt the password in the credential storage structure, and use the password to decrypt the private key in the credential storage structure. However, other devices that are not able to access, or are not configured to access, the key distribution service can obtain the password (e.g., from a user of the device) and use the password to decrypt the private key in the credential storage structure. Thus, the same credential storage structure can be used to provide the same private key to both devices that are able to access the key distribution service and devices that are not able to (or are not configured to) access the key distribution service.

By way of another example, the credential storage structure can store a credential (such as a private key) for a particular user. The user can provide the credential storage structure to various devices and authenticate himself or herself to the key distribution service via those devices. Each such device obtains the key to decrypt the password that is encrypted in the credential storage structure from the key distribution service, decrypts the password, and uses the password to decrypt the credential. The credential can then be used by those devices without the user needing or having knowledge of the password used to decrypt the credential.

Various actions such as communicating, receiving, sending, storing, generating, obtaining, and so forth performed by various modules are discussed herein. It should be noted that the various modules can cause such actions to be performed. A particular module causing an action to be performed includes that particular module itself performing the action, or alternatively that particular module invoking or otherwise accessing another component or module that performs the action (or performs the action in conjunction with that particular module).

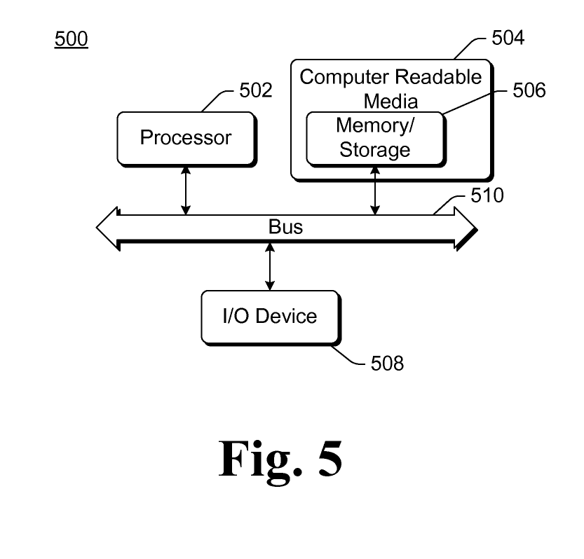

FIG. 5 illustrates an example computing device 500 that can be configured to implement various techniques involving the credential storage structure with encrypted password in accordance with one or more embodiments. Computing device 500 can be, for example, a computing device 104 of FIG. 1, or implement at least part of key distribution service 102 of FIG. 1.

Computing device 500 includes one or more processors or processing units 502, one or more computer readable media 504 which can include one or more memory and/or storage components 506, one or more input/output (I/O) devices 508, and a bus 510 that allows the various components and devices to communicate with one another. Computer readable media 504 and/or one or more I/O devices 508 can be included as part of, or alternatively may be coupled to, computing device 500. Bus 510 represents one or more of several types of bus structures, including a memory bus or memory controller, a peripheral bus, an accelerated graphics port, a processor or local bus, and so forth using a variety of different bus architectures. Bus 510 can include wired and/or wireless buses.

Memory/storage component 506 represents one or more computer storage media. Component 506 can include volatile media (such as random access memory (RAM)) and/or nonvolatile media (such as read only memory (ROM), Flash memory, optical disks, magnetic disks, and so forth). Component 506 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 502. It is to be appreciated that different instructions can be stored in different components of computing device 500, such as in a processing unit 502, in various cache memories of a processing unit 502, in other cache memories of device 500 (not shown), on other computer readable media, and so forth. Additionally, it is to be appreciated that the location where instructions are stored in computing device 500 can change over time.

One or more input/output devices 508 allow a user to enter commands and information to computing device 500, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, applications, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 5. The features of the credential storage structure with encrypted password techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
obtaining a storage structure including an encrypted credential, the encrypted credential being a credential encrypted based on a password;
obtaining a first key;
generating, at a computing device, an encrypted password by encrypting, based on the first key, the password; and
including the encrypted password as part of the storage structure.

2. A method as recited in claim 1, the obtaining the first key comprising obtaining the first key from a key distribution service.

3. A method as recited in claim 1, the obtaining the storage structure comprising generating the storage structure.

4. A method as recited in claim 1, the storage structure further including a data portion including data associated with the credential, the credential comprising a private key of a public/private key pair, and the data associated with the credential comprising a certificate associated with the private key.

5. A method as recited in claim 1, the encrypted credential having been encrypted using a second key derived from the password.

6. A method as recited in claim 1, the obtaining the first key comprising:
providing authentication information to the key distribution service; and
receiving, in response to the key distribution service authenticating the computing device, the first key from the key distribution service.

7. A method as recited in claim 6, the first key comprising a public key of a public/private key pair associated with a group of computing devices.

8. A method as recited in claim 1, the first key comprising a symmetric key.

9. A method as recited in claim 8, the symmetric key being associated with a group of computing devices.

10. A method as recited in claim 1, the first key comprising a public key of a public/private key pair.

11. A method as recited in claim 1, the including the encrypted password as part of the storage structure comprising including the encrypted password as part of the storage structure without preventing the encrypted credential from being decrypted, based on the password, without knowledge of the first key.

12. A method as recited in claim 11, the obtaining the first key comprising obtaining the first key from a key distribution service.

13. One or more computer storage media having stored thereon multiple instructions that, when executed by one or more processors of a computing device, cause the one or more processors to:
obtain a storage structure including both an encrypted credential and an encrypted password;
decrypt, based on a first key, the encrypted password to obtain a password; and
decrypt, based on the password, the encrypted credential to obtain a credential.

14. One or more computer storage media as recited in claim 13, the first key comprising a symmetric key, the multiple instructions further causing the one or more processors to provide authentication information to a key distribution service and obtain, from the key distribution service, the symmetric key.

15. One or more computer storage media as recited in claim 13, the first key comprising a private key of a public/private key pair.

16. One or more computer storage media as recited in claim 15, the multiple instructions further causing the one or more processors to provide authentication information to a key distribution service and obtain, from the key distribution service, the private key.

17. One or more computer storage media as recited in claim 13, the storage structure further including a data portion including data associated with the credential, the credential comprising a private key of a public/private key pair and the data associated with the credential comprising a certificate associated with the private key.

18. One or more computer storage media as recited in claim 13, the storage structure further including a data portion including data associated with the credential, the credential comprising a private key of a public/private key pair and the data associated with the credential comprising a certificate revocation list associated with the private key.

19. One or more computer storage media as recited in claim 13, the instructions that cause the one or more processors to decrypt the encrypted credential comprising instructions that cause the one or more processors to decrypt the encrypted credential without revealing the password to a user of the computing device.

20. A method implemented in a computing device, the method comprising:
obtaining a storage structure including both an encrypted credential, the encrypted credential being a private key of a public/private key pair encrypted based on a password;
obtaining, from a key distribution service in response to authentication information having been provided to the key distribution service, a symmetric key;
generating, at the computing device, an encrypted password by encrypting, based on the symmetric key, the password; and
including the encrypted password as part of the storage structure without preventing the encrypted credential from being decrypted, based on the password, without knowledge of the first key.
